(19) United States
(12) Patent Application Publication
(10) Pub. No.: US 2010/0186311 A1
(43) Pub. Date: Jul. 29, 2010

(54) Border Block and Apparatus for Manufacturing the Same

(76) Inventor: Chair-Suk Jun, Seoul (KR)

Correspondence Address: DOWELL & DOWELL P.C., 103 Oronoco St., Suite 220, Alexandria, VA, 22314, US

(21) Appl. No.: 12/667,518

(22) PCT Filed: Jul. 4, 2008
(86) PCT No.: PCT/KR08/03966

§ 371 Date: Dec. 31, 2009

(30) Foreign Application Priority Data
Jul. 5, 2007 (KR) 10-2007-0067509
Jul. 31, 2007 (KR) 20-2007-0012894
Oct. 16, 2007 (KR) 10-2007-0104103
Jan. 8, 2008 (KR) 10-2008-0002077

(51) Int. Cl. E01C 15/00; B29C 43/18; E04C 2/20

(52) U.S. Cl. 52/102; 156/245; 52/173.1; 52/309.13; 404/71

(57) ABSTRACT

An apparatus for manufacturing a border bock is useable for automatic production of a border block capable of expressing various colors and designs. The border block, includes a block body, and an outer plate adhered to the block body to surround the block body, the outer plate including a transparent outer mat with a picture on an inner surface thereof.

### TECHNICAL FIELD

The present invention relates to a border block and an apparatus for manufacturing the same, and more particularly to a border bock useable for automatic production of a border block capable of expressing various colors and designs and an apparatus for manufacturing the same.

### BACKGROUND ART

A border block is a block installed between a roadway and a sidewalk to distinguish the roadway and the sidewalk. The border block is generally made of concrete or stone.

A concrete border block is advantageous in low price and easy production. However, the concrete border block is not easy in expressing various colors and designs, and it is rapidly corroded in the presence of pollutant substances, so it is abruptly aged after a certain time passes. In particular, the concrete border block should be exchanged frequently since it is cracked or broken due to freezing and melting in winter.

A stone border block is advantageous in beautiful and elegant appearance. However, the stone border block is disadvantageous in high price, great weight, and difficult processing.

### DISCLOSURE

### Technical Problem

The present invention is designed to solve the problems of the prior art, and therefore it is an object of the present invention to provide an apparatus for automatically manufacturing a border block capable of expressing various colors and designs.

Another object of the present invention is to provide a border block not easily corroded by a pollutant substance, and an apparatus for automatically manufacturing such a border block.

Still another object of the present invention is to provide a border block capable of utilizing waste materials to advantageously protect environment and save resources, and an apparatus for automatically manufacturing such a border block.

### Technical Solution

In order to accomplish the above object, the present invention provides a border block, comprising: a block body; and an outer plate adhered to the block body to surround the block body, the outer plate including a transparent outer mat with a picture on an inner surface thereof.

Preferably, the outer plate further includes an inner mat installed between the outer mat and the block body.

In another aspect of the present invention, there is also provided a border block, comprising: a block body; and an outer plate adhered to the block body to surround the block body, wherein the outer plate includes an inner mat adhered to the block body to surround the block body; an intermediate mat adhered to the inner mat to surround the inner mat; and an outer mat adhered to the intermediate mat to surround the intermediate mat, wherein the intermediate mat has a picture thereon, and the outer mat is made of transparent material.

Preferably, the intermediate mat is made of any one selected from the group consisting of a stone plate, a steel plate and a plastic plate.

In another aspect of the present invention, there is also provided a border block, comprising: a block body; an intermediate mat adhered to the block body to surround at least a front surface and an upper surface of the block body, the intermediate mat having a picture on an outer surface thereof, the intermediate mat being made of any one selected from the group consisting of a stone plate, a steel plate and a plastic plate; and a transparent outer plate adhered to surround the intermediate mat in order to protect the picture.

Preferably, the outer plate is adhered to the block body such that a part of a front or rear surface of the block body is exposed outward in order to enhance an adhesive force with a concrete or asphalt of a roadway or a sidewalk.

Preferably, a fixing pin is installed to the block body to pass through the outer plate in order to reinforce the adhesion between the block body and the outer plate.

Preferably, the block body includes at least one of waste foundry sand, waste limestone, waste synthetic resin, waste concrete and waste rubber.

Preferably, the border block according to the present invention further includes a transparent film adhered to the outer plate to surround the outer plate.

In another aspect of the present invention, there is also provided a border block, comprising: a block body having a picture on an outer surface thereof, the block body being made of any one selected from the group consisting of waste stone, waste steel plate and waste wood; and a transparent outer plate installed to surround the block body in order to protect the picture.

In still another aspect of the present invention, there is also provided a border block, comprising: a block body; a plastering layer formed by applying a plaster, in which unsaturated polyester resin, stone powder and pigment are mixed at predetermined ratios, to at least a front surface and an upper surface of the block body; and an outer plate attached to the plastering layer and having a picture on an inner surface thereof, the outer plate being thermally bonded by means of heat generated when the unsaturated polyester resin of the plastering layer is cured.

In further another aspect of the present invention, there is also provided a border block, comprising: a block body; a plastering layer formed by applying a plaster, in which unsaturated polyester resin, stone powder and pigment are mixed at predetermined ratios, to at least a front surface and an upper surface of the block body; an outer plate attached to the plastering layer by impregnation into the unsaturated polyester resin, the outer plate having a picture on an outer surface thereof; and a transparent film surrounding the outer plate to protect the picture, the transparent film being thermally bonded by means of heat generated when the unsaturated polyester resin of the plastering layer is cured.

Preferably, the plastering layer includes 35 weight % to 40 weight % of unsaturated polyester resin and 60 weight % to 65 weight % of stone powder such that the sum of unsaturated polyester resin and stone powder becomes 100 parts by weight, and the plastering layer further includes 0.5 to 1 parts by weight of pigment based on the 100 parts by weight.

In another aspect of the present invention, there is also provided an apparatus for manufacturing a border block, comprising: a pressing unit reciprocating with respect to a block body to press an outer plate, installed to cover at least a part of the block body, such that the outer plate is adhered to the block body.

Preferably, the pressing unit includes an upper frame installed at an upper side of the block body and having a first pressing plate engaged with an upper surface of the block body; a side pressing member having a second pressing plate engaged with a side of the block body and pressing the outer plate against the block body by reciprocating the second pressing plate with respect to both sides of the block body; and a lifting member installed at a lower side of the block body and selectively reciprocating with respect to the block body such that the outer plate is pressed against the upper surface of the block body by means of the first pressing plate.

Preferably, the pressing unit includes an upper frame installed at an upper side of the block body and having a first pressing plate engaged with an upper surface of the block body, the upper frame selectively reciprocating the first pressing plate with respect to the block body such that the outer plate is pressed against the block body; and a side pressing member having a second pressing plate engaged with a side of the block body and pressing the outer plate against the block body by reciprocating the second pressing plate with respect to both sides of the block body.

Preferably, the pressing unit includes an upper frame installed at an upper side of the block body and having a first pressing plate engaged with an upper surface of the block body; a side pressing member having a second pressing plate engaged with a side of the block body and pressing the outer plate against the block body by pivoting the second pressing plate with respect to both sides of the block body; and a lifting member installed at a lower side of the block body and selectively reciprocating with respect to the block body such that the outer plate is pressed against the upper surface of the block body by means of the first pressing plate.

Preferably, the pressing unit includes an upper frame installed at an upper side of the block body and having a first pressing plate engaged with an upper surface of the block body, the upper frame selectively reciprocating the first pressing plate with respect to the block body such that the outer plate is pressed against the block body; and a side pressing member having a second pressing plate engaged with a side of the block body and pressing the outer plate against the block body by pivoting the second pressing plate with respect to both sides of the block body.

Here, the apparatus may further include buffering flat plates respectively installed between the first pressing plate and the outer plate and between the second pressing plate and the outer plate so as to give a buffering action such that pressure applied by the first and second pressing plates are uniformly exerted to the outer plate.

In addition, the apparatus may further include a heating chamber for heating the border block to a predetermined temperature such that the block body is cured fast after being completely adhered to the outer plate.

### DESCRIPTION OF DRAWINGS

Other objects and aspects of the present invention will become apparent from the following description of embodiments with reference to the accompanying drawing in which:

FIG. 1 is a perspective view showing a border block according to a first embodiment of the present invention;

FIG. 2 is a sectional view showing the border block of FIG. 1;

FIG. 3 is a sectional view showing a border block according to a second embodiment of the present invention;

FIG. 4 is a sectional view showing a border block according to a third embodiment of the present invention;

FIG. 5 is a sectional view showing a border block according to a fourth embodiment of the present invention;

FIG. 6 is a perspective view showing a mold mused for manufacturing a border block according to the present invention;

FIGS. 7 and 8 are flowcharts respectively illustrating a process for manufacturing the border block according to the present invention;

FIG. 9 is a plane view showing an apparatus for manufacturing a border block according to a preferred embodiment of the present invention;

FIGS. 10 to 12 are sectional views subsequently showing that a pressing unit provided at the apparatus of FIG. 9 is operated; and

FIGS. 13 to 15 are sectional views subsequently showing that a pressing unit provided at a border block manufacturing apparatus according to another embodiment of the present invention is operated.

### BEST MODE

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

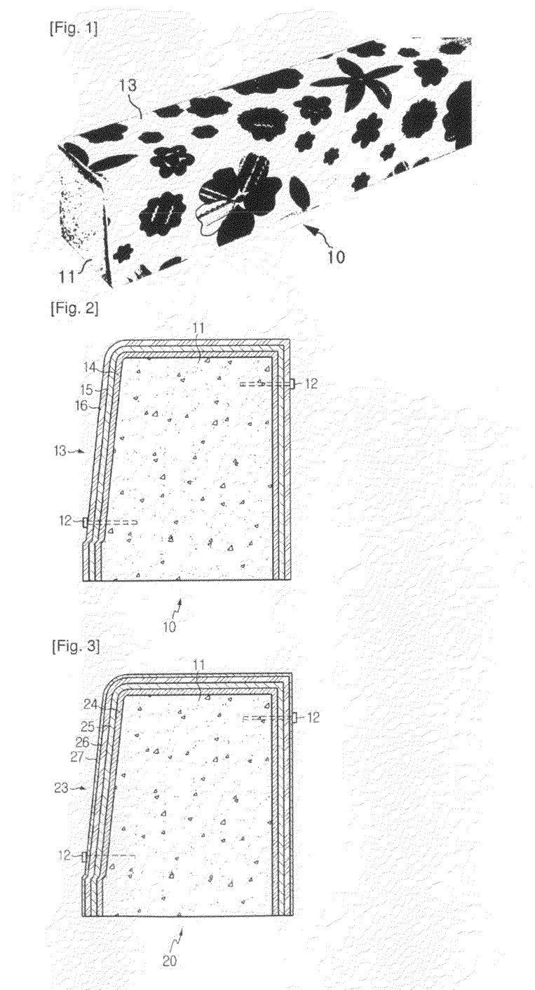

FIG. 1 is a perspective view showing a border block according to a first embodiment of the present invention, and FIG. 2 is a sectional view showing the border block. The border block 10 may express various patterns, designs, letters and logos with various colors (hereinafter, referred to as ‘picture’).

Referring to FIGS. 1 and 2, the border block 10 includes a block body 11, and an outer plate 13 adhered to the block body 11.

The block body 11 has a shape of conventional common border block. Preferably, the block body 11 may be made of any one material selected from concrete, ALC (Autoclaved Lightweight Concrete), mortar, wood, stone and lightweight concrete.

Meanwhile, the block body 11 may be made of waste foundry sand, waste limestone, waste synthetic resin, waste concrete or waste rubber. Also, the block body 11 may be made using waste foundry sand and waste limestone together. Namely, the block body 11 of the present invention should be understood to include all kinds of block bodies 11 made using concrete, ALC, mortar, wood, stone or lightweight concrete; or waste foundry sand, waste limestone, waste synthetic resin, waste concrete or waste rubber. Hereinafter, a block body 11 made using waste foundry sand, waste limestone, waste synthetic resin, waste concrete or waste rubber is explained in more detail.

Waste foundry sand is a material wasted after molding in a casting factory, and in the present invention, such waste foundry sand is recycled as aggregate. A method for making aggregate using waste foundry sand is disclosed in Korean Patent Registration No. 10-0292320.

In case waste foundry sand is used, a mixture for block body, composed of cement, waste foundry sand, gravels, water and compound, is placed in a mold, and it is pressed by vibration under a normal pressure and then cured. After being cured to some extent, the block body 11 is moved to a vapor curing chamber for further curing.

Preferably, a mixture for block body composed of 16.4 kg of cement, 29.7 kg of waste foundry sand, 19.0 kg of gravels, 4.9 kg of water and 164 g of compound (e.g., naphthalene water reducer) is placed in a mold with a top side of 144 mm, a bottom side of 164 mm, a height of 194 mm and a length of 1 m, and then it is pressed by vibration under a normal pressure and then hardened as being left alone. If the block body 11 is hardened to some extent, it is moved to a vapor curing chamber to be cured for 3 hours at 60° C.

In case waste limestone is used, a mixture for block body, composed of cement, sand, gravels, pearlite, waste limestone, water and compound (e.g., naphthalene water reducer), is placed in a mold, and it is pressed by vibration under a normal pressure and then cured. After being cured to some extent, the block body 11 is moved to a vapor curing chamber for further curing.

The used waste limestone may be obtained as a residual product occurring during a cement producing process. Since limestone is a main material of cement, it may be substituted with cement.

Preferably, a mixture for block body composed of 13.8 kg of cement, 6.1 kg of sand, 16.3 kg of gravels, 0.5 kg of pearlite, 6.2 kg of waste limestone, 4.9 kg of water and 140 g of compound (e.g., naphthalene water reducer) is placed in a mold with a top side of 136 mm, a bottom side of 156 mm, a height of 180 mm and a length of 1 m, and then it is pressed by vibration under a normal pressure and then hardened as being left alone. If the block body 11 is hardened to some extent, it is moved to a vapor curing chamber to be cured for 3 hours at 60° C.

In case waste synthetic resin is used, a thermoplastic synthetic resin is frequently used, but a thermosetting synthetic resin may be added thereto to some extent. Among waste synthetic resins collected for recycling, thermoplastic synthetic resins are selected and put into a heating chamber, and then heated to a softening temperature of thermoplastic synthetic resin to obtain fusibility. After fusibility is obtained, the collected waste synthetic resins are put into a heating chamber and then heated and mixed. Among waste synthetic resins, thermoplastic synthetic resins have a softening temperature ranging from about 90° C. to about 290° C., though it differs depending on the kind of resins. For example, a thermoplastic synthetic resin mainly containing polyethylene is heated to the range from 90° C. to 120° C. for softening, PVC (polyvinylchloride) is heated to the range from 120° C. to 150° C. for softening, and PET (polyethyleneterephthalate) is heated to the range from 250° C. to 265° C. for softening. A content ratio of main components in the collected waste synthetic resins may be controlled as desired by adding a separate resin as necessary.

Preferably, waste synthetic resins collected for recycling are selected and controlled such that the content of polyethylene becomes 50 weight % or above, and then they are heated to 110° C. that is a softening temperature of polyethylene. If the waste synthetic resin mixture has fusibility by heating, it is put into a mold having a top side of 140 mm, a bottom side of 160 mm, a height of 190 mm and a length of 1 m, and then it is pressed by vibration and then cooled to make a block body 11.

Waste concrete is used instead of gravels in the mixture for block body. The waste concrete preferably has a maximum thickness of 25 mm or less.

Preferably, in case 1 m³ of a mixture for block body is made, 0.152 m³ of cement, 0.333 m³ of sand, 0.309 m³ of waste concrete, 0.191 m³ of water and 0.015 m³ of AE agent are used.

In case of waste rubber is used, a two-component type resin containing a curing agent is used. Preferably, the resin is mixed with waste rubber by the content of 10% or more in comparison to the weight of waste rubber to make the block body 11. The waste rubber preferably has a maximum particle size of 5 mm.

As mentioned above, the block body 11 may be made of concrete, ALC, mortar, wood, stone, lightweight concrete, waste foundry sand, waste limestone, waste synthetic resin, waste concrete or waste rubber, however the following explanation will be focused only on the case that the block body 11 made of concrete, for convenience.

Meanwhile, the outer plate 13 includes an inner mat 14 adhered to the block body 11 to surround the block body 11, an intermediate mat 15 adhered to the inner mat 14 to surround the inner mat 14, and an outer mat 16 adhered to the intermediate mat 15 to surround the intermediate mat 15. Though the outer plate 13 is adhered to the block body 11 to surround the block body 11, the outer plate 13 is preferably attached to the block body 11 to surround all portions of the block body 11 except its bottom side. The bottom of the block body 11 is directly contacted with concrete or the like (e.g., asphalt concrete) of a roadway or a sidewalk, which may increase a frictional force between the border block 10 and the concrete.

The inner mat 14 prevents a picture on the intermediate mat 15 from being deteriorated by concrete of the block body 11 so as to ensure a clearer picture, and also it reinforces strength of the border block 10. The inner mat 14 may be made of fiber, glass fiber, carbon fiber or the like. The inner mat 14 may be adhered to concrete by means of epoxy resin, unsaturated polyester resin or the like.

A picture is formed on the intermediate mat 15. The picture formed on the intermediate mat 15 may be observed from outside since the outer mat 16 is transparent. The intermediate mat 15 plays a role of expressing the picture and also a role of increasing the strength of the border block 10. Preferably, the intermediate mat 15 may be made of fiber, glass fiber, paper, acryl, synthetic vinyl, non-woven fabric or the like. The intermediate mat 15 preferably has a thickness of 0.1 mm to 2 mm. The intermediate mat 15 is adhered to the inner mat 14 by means of epoxy resin, unsaturated polyester resin or the like.

In addition, the intermediate mat 15 is preferably made of any one of a stone plate, a plastic plate and a steel plate. A picture is formed on an outer surface of the stone plate, the plastic plate or the steel plate. More preferably, the stone plate has a thickness ranging from 5 mm to 15 mm, the steel plate has a thickness ranging from 0.01 mm to 1 mm, and the plastic plate has a thickness ranging from 0.1 mm to 2 mm.

The outer mat 16 plays a role of protecting the picture formed on the intermediate mat 15 and increasing the strength of the border block 10. The outer mat 16 is made of transparent material, for example glass fiber with good transparency. The outer mat 16 preferably has a thickness ranging from 0.1 mm to 2 mm.

Preferably, the border block 10 has fixing pins 12 installed through the outer plate 13. The fixing pins 12 allow firm coupling between the outer plate 13 and the block body 11. The fixing pins 12 are installed at predetermined intervals on front and rear surfaces of the border block 10.

Meanwhile, FIG. 3 is a sectional view showing a border block according to a second embodiment of the present invention.

Referring to FIG. 3, the border block 20 includes a block body 11, an outer plate 23 adhered to the block body 11, and a film 27 adhered to surround the outer plate 23. The block body 11 is identical to the block body 11 of the first embodiment, so it is not explained in detail here.

The outer plate 23 includes an inner mat 24 adhered to the block body 11 to surround the block body 11, an intermediate mat 25 adhered to the inner mat 24 to surround the inner mat 24, and an outer mat 26 adhered to the intermediate mat 25 to surround the intermediate mat 25. The inner mat 24, the intermediate mat 25 and the outer mat 26 are substantially identical to the inner mat 14, the intermediate mat 15 and the outer mat 16 in aspect of their material and structure, so they play the same roles as above.

The film 27 is adhered to surround the outer plate 23 such that the outer plate 23 has a smooth surface without losing its shape. The film 27 is adhered to the outer plate 23 in advance before the outer plate 23 is attached to the block body 11. The outer plate 23 may be removed after being attached to the block body 11, but it may also remain after being attached. In case the film 27 is not removed but remains, the film 27 is coated with a chemical made of acrylic resin and then positioned on the outer mat 26.

The acrylic resin allows the film 27 to have a thermal bonding function. That is to say, if the chemical made of acrylic resin is heated to 70° C. or above after being applied to the film 27, the acrylic resin is melted and thus integrated with the resin impregnated into the outer mat 26. That is to say, the film 27 is thermally bonded to the outer mat 26 permanently.

If the film 27 is not coated with a chemical made of acrylic resin, the film 27 is not thermally bonded, so the film 27 can be removed after the border block 20 is completed. That is to say, the border block may have the same structure as in the first embodiment shown in FIGS. 1 and 2.

Preferably, the film 27 may be made of PET or the like, and it may have a UV blocking function. The film 27 preferably has a thickness ranging from 10 microns to 100 microns.

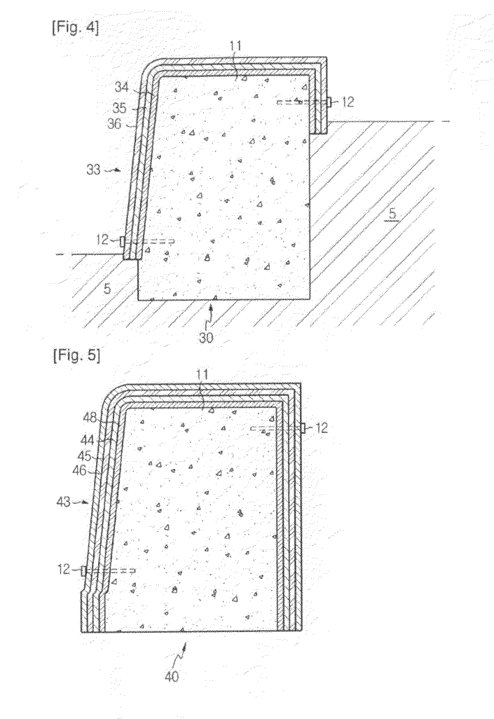

Meanwhile, FIG. 4 is a sectional view showing a border block according to a third embodiment of the present invention.

Referring to FIG. 4, the border block 30 includes a block body 11, and an outer plate 33 adhered to the block body 11. The block body 11 is identical to the block body 11 of the first embodiment, so it is not explained in detail here.

The outer plate 33 includes an inner mat 34 adhered to the block body 11 to surround the block body 11, and am intermediate mat 35 adhered to the inner mat 34 to surround the inner mat 34, and an outer mat 36 adhered to the intermediate mat 35 to surround the intermediate mat 35. The inner mat 34, the intermediate mat 35 and the outer mat 36 are respectively identical to the inner mat 14, the intermediate mat 15 and the outer mat 16 in aspect of their materials and roles.

The outer plate 33 is adhered to the block body 11 such that a bottom side, a part of a front side and a part of a rear side of the block body 11 are directly exposed outward. It facilitates the increase of frictional force between the block body 11 and a surrounding concrete 5. In addition, in this configuration, it is possible to reduce a cost required for making the outer plate 33.

Preferably, the outer plate 33 is attached to the block body 11 to surround the block body 11 up to a height slightly lower than the height to which the surrounding concrete (including asphalt concrete) 5 are filled around the border block 30.

Meanwhile, FIG. 5 is a sectional view showing a border block according to a fourth embodiment of the present invention.

Referring to FIG. 5, the border block 40 includes a block body 11, a plastering layer 48 coated on the block body 11, and an outer plate 43 adhered to the plastering layer 48 to surround the block body 11. The block body 11 is identical to the block body 11 of the first embodiment, so it is not explained in detail here.

The outer plate 43 includes an inner mat 44 adhered to the plastering layer 48 to surround the block body 11, and an intermediate mat 45 adhered to the inner mat 44 to surround the inner mat 44, and an outer mat 46 adhered to the intermediate mat 45 to surround the intermediate mat 45. The inner mat 44, the intermediate mat 45 and the outer mat 46 are respectively identical to the inner mat 14, the intermediate mat 15 and the outer mat 16 in aspect of their materials and roles.

The plastering layer 48 is applied to at least a front side and an upper side of the block body 11. Preferably, the plastering layer 48 is applied to surround all portions of the block body 11 except its bottom side and then cured. Thus, the block body 11 may have improved durability. Also, the pigment contained in the plastering layer 48 plays a role of background color, so the picture formed on the outer plate 43 may be expressed more clearly. In addition, though an attachment surface of the block body 11 is irregular, the plastering layer 48 applied to and cured on the block body 11 improves flatness, so the outer plate 43 may be attached thereto without any irregularity.

Here, the plastering layer 48 is a plaster including 35 weight % to 40 weight % of unsaturated polyester resin and 60 weight % to 65 weight % of stone powder such that the sum of unsaturated polyester resin and stone powder becomes 100 parts by weight, and also further including 0.5 to 1 parts by weight of pigment based on the 100 parts by weight. At this time, the slump is preferably ranging from 15 cm to 20 cm in consideration of suitable strength and easiness of coating.

If the plastering layer 48 composed of the above plaster is applied to the block body 11, the outer plate 43 is attached thereto before the plastering layer 48 is cured. Then, as time goes, the unsaturated polyester resin of the plastering layer 48 is cured, so the outer plate 43 is integrally thermally bonded to the plastering layer 48, thereby completing the border block 40.

Meanwhile, though not shown in the figures, a transparent film may be attached to surround the outer plate 43. The film is adhered by the heat generated as the unsaturated polyester resin is cured, identically to the case that the outer plate 43 is adhered to the plastering layer 48 by thermal bonding.

Meanwhile, though the border block 10, 20, 30, 40 including the outer plate 13, 23, 33, 43 composed of the inner mat 14, 24, 34, 44, the intermediate mat 15, 25, 35, 45 and the outer mat 16, 26, 36, 46 has been illustrated, only the outer mat 16, 26, 36, 46 may be attached to the border block 10, 20, 30, 40. That is to say, it is possible that a picture is formed on the inner surface of the outer mat 16, 26, 36, 46, and the outer mat 16, 26, 36, 46 is directly attached to the block body 11.

In addition, only the outer mat 16, 26, 36, 46 and the inner mat 14, 24, 34, 44 may be attached to the border block. That is to say, it is possible that a picture is formed on the inner surface of the outer mat 16, 26, 36, 46, and the outer mat 16, 26, 36, 46 is attached to the inner mat 14, 24, 34, 44.

Also, only the outer mat 16, 26, 36, 46 and the intermediate mat 15, 25, 35, 45 may be attached to the border block. That is to say, it is possible that a picture is formed on the intermediate mat 15, 25, 35, 45, the intermediate mat 15, 25, 35, 45 is directly attached to the block body 11, and the outer mat 16, 26, 36, 46 is attached to the intermediate mat 15, 25, 35, 45.

The above border blocks 10, 20, 30, 40 are just examples of various embodiments. That is to say, the film 27 may be selectively attached to the outer plate 13, 23, 33, 43. Also, it is possible that only the inner mat 14, 24, 34, 44 having a picture and the film 27 are attached to the border block, the intermediate mat 15, 25, 35, 45 having a picture and the film 27 may be attached to the border block, or only the outer mat 16, 26, 36, 46 having a picture and the film 27 may be attached to the border block.

Meanwhile, the border block may include a block body having a picture formed on an outer surface thereof, and an outer plate installed to surround the block body so as to protect the picture. The block body is made of any one of waste stone, waste steel plate and waste wood, and the outer plate is transparent. This border block is manufactured in a way of making a block body using at least one of waste stone, waste steel plate and waste wood, obtained by recycling waste materials, then forming a picture on an outer surface of the block body, and then installing a transparent outer plate to the block body.

In addition, though the border block may be made in a way of making a block body and then attaching an outer plate thereto, a border block may also be made in a way of attaching an outer plate to an existing block body product.

Now, a method for manufacturing the border block 10 according to the first embodiment of the present invention is explained. The methods for manufacturing the border blocks 20, 30, 40 according to the second to fourth embodiment of the present invention will be apparent to those having ordinary skill in the art from the first embodiment, so they are not explained in detail here.

The border block 10 may be manufacturing by means of placing concrete or the like to the outer plate 13 (hereinafter, referred to as a ‘first scheme’) or attaching the outer plate 13 to a prepared block body 11 (hereinafter, referred to as a ‘second scheme’).

First, the first scheme is explained with reference to FIG. 7.

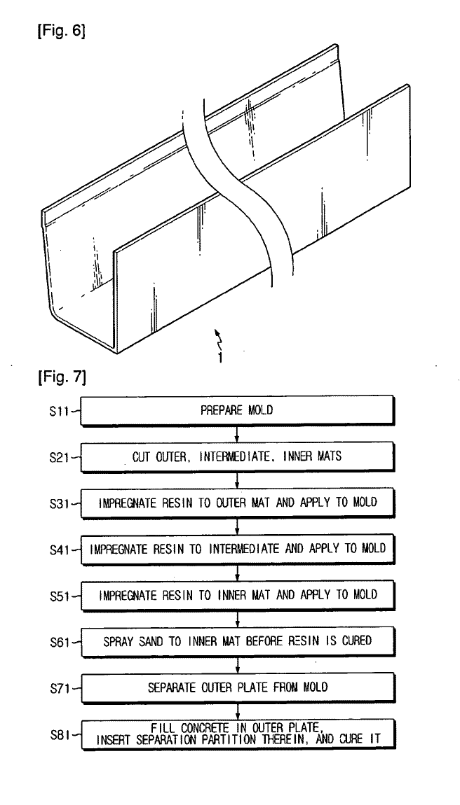

In order to make a border block using the first scheme, a mold 1 (see FIG. 6) is prepared (S11). The mold 1 has an elongated shape in a length direction, and a section of the mold 1 is engaged with a section of the outer plate 13.

After the mold 1 is prepared, the outer mat 16, the intermediate mat 15 and the inner mat 14 are cut suitably (S21).

Subsequently, a resin is impregnated into the outer mat 16, and then the outer mat 16 is applied to the mold 1 (S31). Then, a resin is impregnated into the intermediate mat 15, and then the intermediate mat 15 is applied to the outer mat 16 (S41). Also, a resin is impregnated into the inner mat 14, and the inner mat 14 is applied to the intermediate mat 15 (S51). As explained above, a picture is formed on the intermediate mat 15, and the outer mat 16 is transparent, so the picture may be observed from the outside. For impregnation of the outer mat 16, the intermediate mat 15 and the inner mat 14, an epoxy resin or an unsaturated polyester rein may be used.

After the inner mat 14 is applied to the intermediate mat 15, sands are sprayed to the inner mat 14 before the resin is cured (S61). The sands play a role of enhancing a coupling force between the outer plate 13 and the block body 11.

Subsequently, the outer plate 13 is separated from the mold 1 (S71).

After the outer plate 13 is separated, concrete is filled in the outer plate 13, a separation partitions (not shown) are installed to the outer plate, and then the concrete is cured (S81). The separation partitions are installed to the outer plate 13 at predetermined intervals. The predetermined intervals are determined depending on a length of a border block 10 to be made.

Before the concrete is placed to the outer plate 13, before the concrete is cured after being placed, or after the concrete is cured, the fixing pins 12 may be installed to the border block 10.

Meanwhile, in order to make a block body using waste material as mentioned above, a mixture for block body may be filled in the outer plate 13. At this time, the process of installing a separation partition to the outer plate 13 and then making a block body by curing is identical to that using concrete. The mixture for block body includes at least one of waste foundry sand, waste limestone, waste synthetic resin, waste concrete and waste rubber. Also, the mixture for block body may include all of waste foundry sand and waste limestone. The method for making the mixture for block body is already explained above.

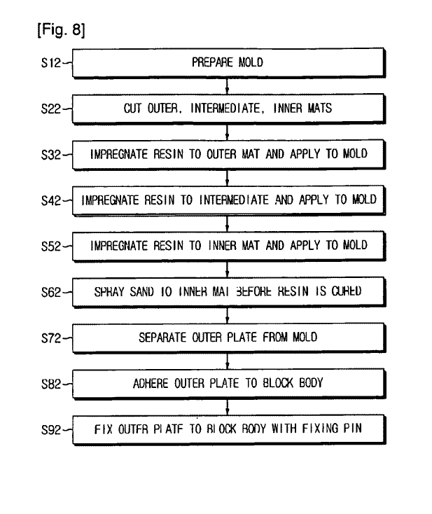

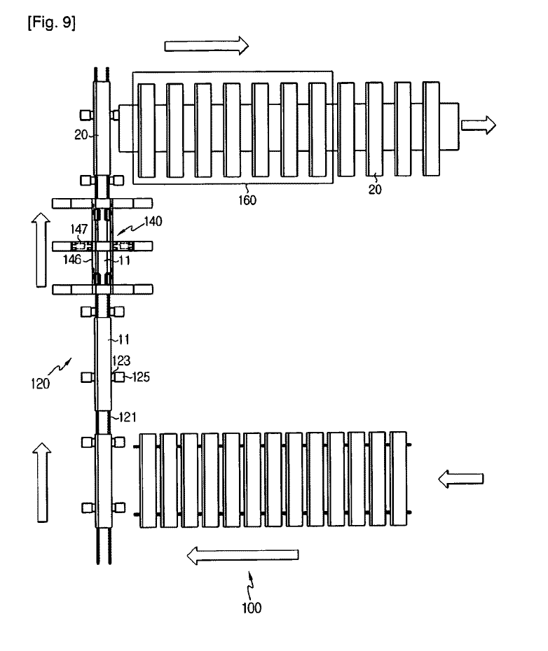

Subsequently, the second scheme is explained with reference to FIG. 8.

In the second scheme, the processes (S12 to S72) of making the outer plate 13 are identical to those of the first scheme. That is to say, the processes S12 to S72 are identical to the processes S11 to S71.

After the outer plate 13 is made, the outer plate 13 is adhered to the block body 11 (S82). The block body 11 is made using concrete, ALC, lightweight concrete, wood, stone, mortar, waste foundry sand, waste limestone, waste synthetic resin, waste concrete or waste rubber. Meanwhile, an existing border block may also be used instead of the above block body 11. That is to say, the border block 10 may also be made by attaching the outer plate 13 to an existing border block. In order to adhere the outer plate 13 to the block body 11, an epoxy resin or an unsaturated polyester resin may be used.

After the outer plate 13 is completely adhered, the outer plate 13 is fixed to the block body 11 by means of the fixing pins 12 (S92).

Meanwhile, though the above explanation has been focused on the method for manufacturing a border block 10 having an outer plate 13 composed of an inner mat 14, an intermediate mat 15 and an outer mat 16, a method for making a border block in which the outer plate is composed of only an outer mat, only an outer mat and an inner mat, or only an outer mat and an intermediate mat may also be apparently understood from the above method. Also, a method for applying a plaster to the block body to form a plastering layer and then adhering the plastering layer to the outer plate will be also easily understood from the above method.

Now, an apparatus for manufacturing the above border block is explained. Meanwhile, for the convenience, only a process of manufacturing the border block 20 having the outer plate 23 as shown in FIG. 3 is explained.

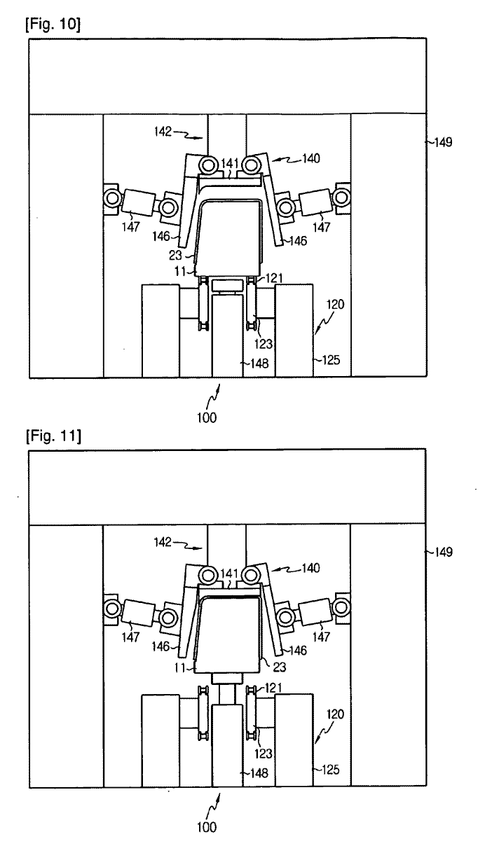

At this time, the outer plate 23 may include only the outer mat 26 having a picture, only the outer mat 26 and the intermediate mat 25 having a picture, or only the inner mat 24 and the outer mat 26 having a picture. However, for the convenience, the following explanation will be focused on only the case that the outer plate 23 includes an outer mat 26, an intermediate mat 25 having a picture, and an inner mat 24. Meanwhile, a film 27 may be installed out of the outer mat 26 before first and second pressing plates 141, 146 (see FIG. 10) press the outer plate 23. The film 27 is already explained above.

FIG. 9 is a plane view showing an apparatus for manufacturing a border block according to a preferred embodiment of the present invention, and FIGS. 10 to 12 are sectional views subsequently showing that a pressing unit provided to the apparatus is operated.

Referring to FIGS. 9 to 12, the border block manufacturing apparatus 100 includes a carrying unit 120 for carrying a block body 11, and a pressing unit 140 for adhering an outer plate 23 to the block body 11.

The carrying unit 120 includes a carrying chain 121 installed as an endless track, and support rollers 123 installed at predetermined intervals to support the carrying chain 121. The carrying unit 120 passes via the pressing unit 140 while loading a block body 11 thereon.

The carrying chain 121 is moved by a driving motor (not shown), and it carries the block body 11 or the border block 20 loaded thereon. The support rollers 123 are rotatably installed to a support 125 and support the carrying chain 121.

The pressing unit 140 includes a frame 149, an upper frame 142, a side pressing member for pressing a side of the block body 11, and a lifting member 148 for lifting the block body 11. The pressing unit 140 presses the outer plate 23 to be adhered to the block body 11. The block body 11, the outer plate 23 and the method for making the outer plate 23 have been already explained, so they are not explained again.

If the block body 11 is carried by the carrying unit 120 and thus moved to the pressing unit 140, a worker positions an outer plate (not having a film 27) onto the block body 11 and then covers the film 27 on the outer plate 23.

The upper frame 142 is installed to the frame 149 above the block body 11, and it has a first pressing plate 141 engaged with the upper surface of the block body 11.

The side pressing member includes a second pressing plate 146 engaged with the side of the block body 11, and a pivoting cylinder 147 for pivoting the second pressing plate 146 with respect to both sides of the block body 11. The side pressing members are respectively installed to both sides of the block body 11.

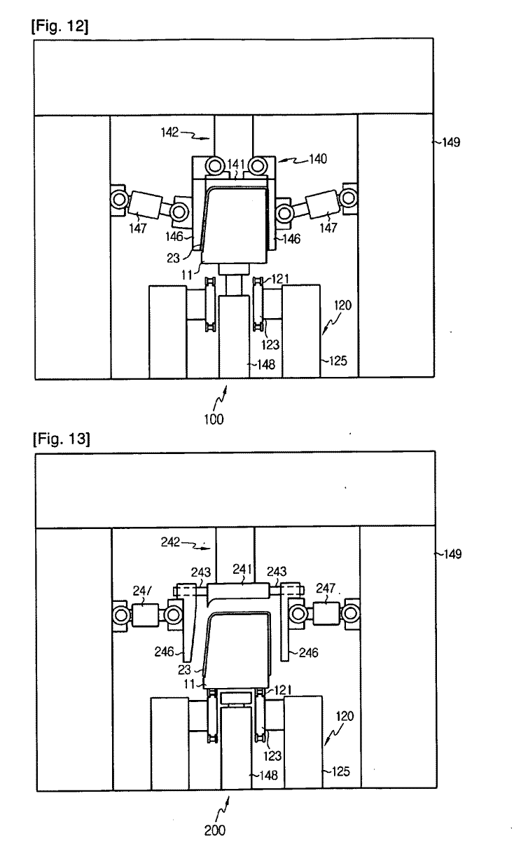

Preferably, the second pressing plate 146 is pivotally installed to the upper frame 142. Also, one end of the pivoting cylinder 147 is rotatably connected to the second pressing plate 146, and the other end of the pivoting cylinder 147 is rotatably installed to the frame 149. Thus, as shown in FIGS. 11 and 12, if the pivoting cylinder 147 is elongated, the second pressing plate 146 is pivoted with respect to the side of the block body 11, thereby pressing the outer plate 23 toward the side of the block body 11.

The lifting member 148 is installed below the block body 11 and selectively lifts the block body 11. As shown in FIG. 10, the lifting member 148 includes a lifting cylinder. If the lifting cylinder is extended, the block body 11 is moved up. Also, if the block body 11 is moved up, the outer plate 23 is pressed by means of the first pressing plate 141, so the outer plate 23 is contacted with the upper surface of the block body 11.

For the adhesion between the outer plate 23 and the block body 11, an adhesive material is applied to the block body 11. The adhesive material may adopt an epoxy resin, an unsaturated polyester resin, or the like, but preferably a resin and calcium carbonate are mixed in a ratio of 5:5 and then used.

Preferably, the manufacturing apparatus 100 includes buffering flat plates (not shown) respectively installed between the first pressing plate 141 and the outer plate 23 and between the second pressing plate 146 and the outer plate 23. The buffering flat plates play a buffering role such that the pressure exerted by the first pressing plate 141 and the second pressing plate 146 may be uniformly applied to the outer plate 23. The buffering flat plates may use a rubber plate with a predetermined cushion.

If the block body 11 is moved to the pressing unit 140 by the carrying unit 120, a work positions the output plate (not having a film 27) to the block body 11, covers the film 27 on the outer plate, and then installs the buffering flat plate on the film 27.

The manufacturing apparatus 100 may further includes a heating chamber 160 for heating a border block to a predetermined temperature such that the outer plate 23 may be cured fast after the block body 11 and the outer plate 23 are completely adhered to each other. After the outer plate 23 and the block body 11 are completely adhered in the pressing unit 140, the border block 20 is carried to the heating chamber 160 by the carrying chain 121. The heating chamber 160 enhances a production speed of the border block 20 by means of fast curing of the outer plate 23. The heating chamber 160 includes a heater (not shown) for heating the inside of the heating chamber 160, a temperature sensor (not shown) for measuring the inner temperature of the heating chamber 160, and a controller (not shown) for controlling operations of the heater according to the temperature measured by the temperature sensor.

Preferably, the heating chamber 160 is heated to a temperature ranging from 70° C. to 150° C., and the border block 20 is kept for about 5 to 10 minutes in the heating chamber 160.

Meanwhile, for firm coupling between the outer plate 23 and the block body 11, the fixing pin 12 may be selectively installed through the block body 11.

FIGS. 13 to 15 are sectional views subsequently showing that a pressing unit provided at the border block manufacturing apparatus according to another embodiment of the present invention is operated.

Referring to FIGS. 13 to 15, the border block manufacturing apparatus 200 includes a carrying unit 120 for carrying a block body 11, and a pressing unit 240 for adhering an outer plate 23 to the block body 11. The carrying unit 120 is substantially identical to the carrying unit 120 of the first embodiment, so it is not explained in detail here.

The pressing unit 240 includes a frame 149, an upper frame 242 installed to the frame 149, a side pressing member for reciprocating a second pressing plate 246 with respect to both sides of the block body 11, and a lifting member 148 installed below the block body 11. Among the above components, the lifting member 148 is substantially identical to the lifting member 148 of the former embodiment, so it is not explained in detail here.

The upper frame 242 is installed at an upper side of the block body 11, and it has a first pressing plate 241 engaged with an upper surface of the block body 11. Preferably, the upper frame 242 has a guide rod 243 installed to a side of the upper frame 242. The guide rod 243 is explained in detail later.

The side pressing member has a second pressing plate 246 engaged with a side of the block body 11, and it reciprocates the second pressing plate 246 with respect to both sides of the block body 11, thereby pressing the outer plate 23 toward the block body 11. The side pressing member is installed to both sides of the block body 11.

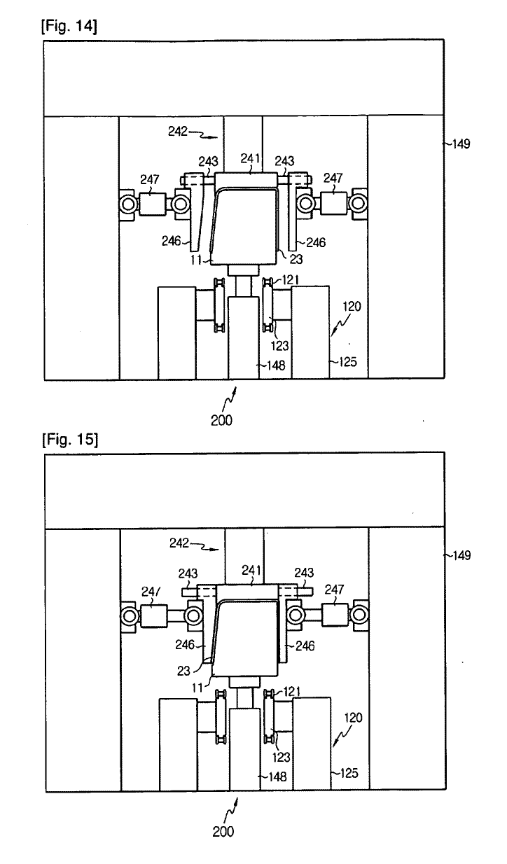

Preferably, the side pressing member includes a second pressing plate 246 reciprocating by guidance of the guide rod 243 and engaged with the side of the block body 11, and a carrying cylinder 247 for reciprocating the second pressing plate 246. As shown in FIGS. 14 and 15, if the carrying cylinder 247 is extended, the second pressing plate 246 is moved by guidance of the guide rod 243 and thus presses the outer plate 23 toward the block body 11. If the second pressing plate 246 presses the outer plate 23 toward the block body 11, the outer plate 23 and the block body 11 are adhered to each other by adhesive material. The adhesive material is already explained above.

Meanwhile, this manufacturing apparatus 200 may also further include a buffering flat plate (not shown) and a heating chamber. The buffering flat plate (not shown) and the heating chamber have the same structure as the buffering flat plate (not shown) and the heating chamber 160 of the former embodiment, so they are not explained in detail again.

Meanwhile, though it has been illustrated that the block body 11 is moved up or down by the lifting member 148, it is also possible that the block body 11 is in a fixed state to the carrying chain 121, and the upper frame 142, 242 moves up or down to adhere the outer plate 23 and the block body 11 with each other. That is to say, without any lifting member 148, the upper frame 142, 242 is moved up or down to press the outer plate 23 toward the block body 11, thereby allowing the outer plate 23 and the block body 11 to be adhered with each other.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

As described above, the border block and its manufacturing apparatus according to the present invention gives the following effects.

First, it is possible to express various kinds of pictures on the border block. Thus, road environments may be improved visually.

Second, mass production of the border block is possible, which allows cost reduction for production. Thus, the border block may have a low price.

Third, the block body is surrounded by an outer plate, so it is not easily corroded by pollutant substances.

Fourth, the outer plate may be adhered to an existing border block economically.

Fifth, the border block may be easily made in comparison to stone border blocks.

Sixth, the border block is advantageous in aspect of environment protection and resource saving since waste materials may be utilized.

Seventh, a plastering layer or an outer plate is attached to the block body, so the border block may have reinforced durability.

1. A border block, comprising:
a block body; and
an outer plate adhered to the block body to surround the block body, the outer plate including a transparent outer mat with a picture on an inner surface thereof.

2. The border block according to claim 1,
wherein the outer plate further includes an inner mat installed between the outer mat and the block body.

3. A border block, comprising:
a block body; and
an outer plate adhered to the block body to surround the block body,
wherein the outer plate includes:
an inner mat adhered to the block body to surround the block body;
an intermediate mat adhered to the inner mat to surround the inner mat; and
an outer mat adhered to the intermediate mat to surround the intermediate mat,
wherein the intermediate mat has a picture thereon, and the outer mat is made of transparent material.

4. The border block according to claim 3,
wherein the intermediate mat is made of any one selected from the group consisting of a stone plate, a steel plate and a plastic plate.

5. A border block, comprising:
a block body;
an intermediate mat adhered to the block body to surround at least a front surface and an upper surface of the block body, the intermediate mat having a picture on an outer surface thereof, the intermediate mat being made of any one selected from the group consisting of a stone plate, a steel plate and a plastic plate; and
a transparent outer plate adhered to surround the intermediate mat in order to protect the picture.

6-9. (canceled)

10. A border block, comprising:
a block body having a picture on an outer surface thereof, the block body being made of any one selected from the group consisting of waste stone, waste steel plate and waste wood; and
a transparent outer plate installed to surround the block body in order to protect the picture.

11. A border block, comprising:
a block body;
a plastering layer formed by applying a plaster, in which unsaturated polyester resin, stone powder and pigment are mixed at predetermined ratios, to at least a front surface and an upper surface of the block body; and
an outer plate attached to the plastering layer and having a picture on an inner surface thereof, the outer plate being thermally bonded by means of heat generated when the unsaturated polyester resin of the plastering layer is cured.

12. A border block, comprising:
a block body;
a plastering layer formed by applying a plaster, in which unsaturated polyester resin, stone powder and pigment are mixed at predetermined ratios, to at least a front surface and an upper surface of the block body;
an outer plate attached to the plastering layer by impregnation into the unsaturated polyester resin, the outer plate having a picture on an outer surface thereof; and
a transparent film surrounding the outer plate to protect the picture, the transparent film being thermally bonded by means of heat generated when the unsaturated polyester resin of the plastering layer is cured.

13. (canceled)

14. An apparatus for manufacturing a border block, comprising:
a pressing unit reciprocating with respect to a block body to press an outer plate, installed to cover at least a part of the block body, such that the outer plate is adhered to the block body.

15. The apparatus according to claim 14, wherein the pressing unit includes:
an upper frame installed at an upper side of the block body and having a first pressing plate engaged with an upper surface of the block body;
a side pressing member having a second pressing plate engaged with a side of the block body and pressing the outer plate against the block body by reciprocating the second pressing plate with respect to both sides of the block body; and
a lifting member installed at a lower side of the block body and selectively reciprocating with respect to the block body such that the outer plate is pressed against the upper surface of the block body by means of the first pressing plate.

16. The apparatus according to claim 14, wherein the pressing unit includes:
an upper frame installed at an upper side of the block body and having a first pressing plate engaged with an upper surface of the block body, the upper frame selectively reciprocating the first pressing plate with respect to the block body such that the outer plate is pressed against the block body; and
a side pressing member having a second pressing plate engaged with a side of the block body and pressing the outer plate against the block body by reciprocating the second pressing plate with respect to both sides of the block body.

17. The apparatus according to claim 14, wherein the pressing unit includes:
an upper frame installed at an upper side of the block body and having a first pressing plate engaged with an upper surface of the block body;
a side pressing member having a second pressing plate engaged with a side of the block body and pressing the outer plate against the block body by pivoting the second pressing plate with respect to both sides of the block body; and
a lifting member installed at a lower side of the block body and selectively reciprocating with respect to the block body such that the outer plate is pressed against the upper surface of the block body by means of the first pressing plate.

18. The apparatus according to claim 14, wherein the pressing unit includes:
an upper frame installed at an upper side of the block body and having a first pressing plate engaged with an upper surface of the block body, the upper frame selectively reciprocating the first pressing plate with respect to the block body such that the outer plate is pressed against the block body; and
a side pressing member having a second pressing plate engaged with a side of the block body and pressing the outer plate against the block body by pivoting the second pressing plate with respect to both sides of the block body.

19-20. (canceled)

21. The border block according to claim 1,
wherein the outer plate is adhered to the block body such that a part of a front or rear surface of the block body is exposed outward in order to enhance an adhesive force with a concrete or asphalt of a roadway or a sidewalk.

22. The border block according to claim 1,
wherein a fixing pin is installed to the block body to pass through the outer plate in order to reinforce the adhesion between the block body and the outer plate.

23. The border block according to claim 1,
wherein the block body includes at least one of waste foundry sand, waste limestone, waste synthetic resin, waste concrete and waste rubber.

24. The border block according to claim 1, further comprising a transparent film adhered to the outer plate to surround the outer plate.

25. The border block according to claim 3,
wherein the outer plate is adhered to the block body such that a part of a front or rear surface of the block body is exposed outward in order to enhance an adhesive force with a concrete or asphalt of a roadway or a sidewalk.

26. The border block according to claim 3,
wherein a fixing pin is installed to the block body to pass through the outer plate in order to reinforce the adhesion between the block body and the outer plate.

27. The border block according to claim 3,
wherein the block body includes at least one of waste foundry sand, waste limestone, waste synthetic resin, waste concrete and waste rubber.

28. The border block according to claim 3, further comprising a transparent film adhered to the outer plate to surround the outer plate.

29. The border block according to claim 5,
wherein a fixing pin is installed to the block body to pass through the outer plate in order to reinforce the adhesion between the block body and the outer plate.

30. The border block according to claim 5,
wherein the block body includes at least one of waste foundry sand, waste limestone, waste synthetic resin, waste concrete and waste rubber.

31. The border block according to claim 5, further comprising a transparent film adhered to the outer plate to surround the outer plate.

32. The border block according to claim 11,
wherein the plastering layer includes 35 weight % to 40 weight % of unsaturated polyester resin and 60 weight % to 65 weight % of stone powder such that the sum of unsaturated polyester resin and stone powder becomes 100 parts by weight, and the plastering layer further includes 0.5 to 1 parts by weight of pigment based on the 100 parts by weight.

33. The border block according to claim 12,
wherein the plastering layer includes 35 weight % to 40 weight % of unsaturated polyester resin and 60 weight % to 65 weight % of stone powder such that the sum of unsaturated polyester resin and stone powder becomes 100 parts by weight, and the plastering layer further includes 0.5 to 1 parts by weight of pigment based on the 100 parts by weight.

34. The apparatus according to claim 15, further comprising buffering flat plates respectively installed between the first pressing plate and the outer plate and between the second pressing plate and the outer plate so as to give a buffering action such that pressure applied by the first and second pressing plates are uniformly exerted to the outer plate.

35. The apparatus according to claim 16, further comprising buffering flat plates respectively installed between the first pressing plate and the outer plate and between the second pressing plate and the outer plate so as to give a buffering action such that pressure applied by the first and second pressing plates are uniformly exerted to the outer plate.

36. The apparatus according to claim 17, further comprising buffering flat plates respectively installed between the first pressing plate and the outer plate and between the second pressing plate and the outer plate so as to give a buffering action such that pressure applied by the first and second pressing plates are uniformly exerted to the outer plate.

37. The apparatus according to claim 18, further comprising buffering flat plates respectively installed between the first pressing plate and the outer plate and between the second pressing plate and the outer plate so as to give a buffering action such that pressure applied by the first and second pressing plates are uniformly exerted to the outer plate.

38. The apparatus according to claim 14, further comprising a heating chamber for heating the border block to a predetermined temperature such that the block body is cured fast after being completely adhered to the outer plate.
